(19) United States
(12) Patent Application Publication
(10) Pub. No.: US 2004/0145535 A1
(43) Pub. Date: Jul. 29, 2004

(54) Process control system with image representation system

(76) Inventors: Uwe Gerk, Frensdorf (DE); Marcel Kellner, Erlangen (DE)

Correspondence Address: HARNESS, DICKEY & PIERCE, P.L.C., P.O.BOX 8910, RESTON, VA, 20195, US

(21) Appl. No.: 10/472,365

(22) PCT Filed: Mar. 8, 2002
(86) PCT No.: PCT/DE02/00835

(30) Foreign Application Priority Data
Mar. 23, 2001 (DE) 101 14 701.5

(51) Int. Cl. G09G 5/00

(52) U.S. Cl. 345/1.3

(57) ABSTRACT

According to the invention, a process control system comprises an image representation system (7) with which a process image may be distributed across several display devices (9). Said image representation system (7) comprises a graphic adapter (12), modified for determining the distribution of the process image on the display devices (9) in a internal memory (S) on the graphic adapter and to control the display devices (9) for display of the process image with the corresponding process image distribution data for each of the above.

Modern process control systems are used to monitor the operation of a technical installation, to perform particular operations and functions in the installation automatically and, in the event of an error, to ensure safe control of the installation without damage to humans and/or material arising in the process. Examples of such installations are power plants for generating electrical energy, production installations, chemical installations and many more.

Most known technical installations are still operated, at least in part, by personnel which has access to the process control system and hence to the operation of the installation. Normally, a process control system comprises a computer system having visual display units, for example screens, on which information about the current and/or historical and/or expected future operating state of the installation is shown.

Although a very large number of functions in a technical installation are now actually being performed automatically by the process control system without human intervention, there nevertheless remain a series of demands on the operating personnel which need to be attended to.

To perform their tasks, the operating personnel needs to obtain information about the operating state of the installation from the process control system in the clearest, best conditioned and most readable form of presentation possible. To this end, it is possible and known practice, by way of example, to show one or more information-containing process images, which are stored in a computer of the process control system and are updated during operation, on a screen and thus to make them accessible to the operating personnel.

A drawback in this context is that screens which are normally used are very small, which means that only a few people can be informed about the operating state of the installation simultaneously and they need to be in the immediate vicinity of the screen. If the operating personnel is currently further away from the screen or is a long way to the side of the image area of the screen or is on the opposite side of the screen from the image area, then the information shown can no longer be received at this time. Critical situations which would urgently necessitate human intervention can thus be missed and can result in a hazard.

In addition, a screen provides only limited space, which means that the number of information items which can be shown is limited as a result.

To overcome these drawbacks, it is also known practice to use a plurality of screens in order to increase the size of the area for showing a process image in this way.

A drawback in this context is that—if a process image needs to be shown distributed over a plurality of screens—the process image's distribution over the number of screens needs to be calculated, at the very latest when three screens are used, using an additional computer which specializes in this task (“image split computer”); if the described function of the image split computer were to be integrated into a process computer, then the latter's computation resources would be greatly burdened by the function of calculating the image split such that this would greatly impair the desired and planned functionality of process control and would severely lower the processing speed and data update rate, for example.

An additionally required computer for providing the aforementioned distributed image representation represents considerable additional involvement for configuration and for the costs which need to be found, however; furthermore, an additional computer means an additional source of error in the computer system.

In addition, large-image projection systems are known in which a plurality of screen units are combined to form an overall unit and which are likewise driven by a specialized image split computer; by way of example, the MX terminal offered by the company Dr. Seuffert and the associated MMT system are commercially available. These systems are very complex, have the drawbacks described and are also very expensive.

In addition, large-image projection systems, in particular, are usually designed for operation under the UNIX operating system or derivatives thereof, which means that it is not readily possible to use them under the widely used operating system Microsoft Windows.

The company Colorgraphic Communications Corporation in Atlanta sells graphics cards from the “Predator” range for the field of specialized drawing production (“Computer Aided Design” CAD”); the technical characteristics of these graphics cards are tailored specifically to the requirements of drawing production under the operating system Microsoft Windows.

The specialists operating in the field of automation and/or control technology have to date not recognized the opportunity and necessity for replacing the image split computer which is needed for showing a process image on a plurality of image screens with a simpler device which is easier to produce, can be used more flexibly—particularly with respect to the various possible image resolutions as well—and is also cheaper to produce.

The invention is therefore based on the object of specifying a process control system having an image representation system which makes it a simple matter to split and show a process image over a plurality of visual display units.

The invention achieves the object by means of a process control system having an image representation system which can be used to split a process image over a plurality of visual display units, where the image representation system comprises a graphics adapter which is capable of ascertaining the split of the process image over the visual display units in a graphics-adapter-internal memory and of driving the visual display units for the purpose of showing the process image using the respective associated process image split data ascertained.

A process control system in accordance with the invention makes the use of one or more multichannel image split computers superfluous by transferring the latter's functionality to the graphics adapter, which uses an internal memory to perform the calculations which are necessary in order to drive a plurality of visual display units, particularly screens and/or image projection systems of every available projection surface size, such that the representation of a process image is distributed over the visual display unit.

The graphics adapter is advantageously a PC-compatible graphics card, preferably for use under the operating system Microsoft Windows, having at least three, preferably four, video channels, and the graphics-adapter-internal memory has a minimum size of 32 MB per video channel.

The described number of at least three, preferably four, video channels provides the sizes normally demanded commercially for a control system having an image representation system; the information which can be shown on three or four visual display units is adequate, in terms of the number of information items, for providing the operating personnel with a sufficiently detailed information image of the operating state of the technical installation without overburdening the operating personnel when recording the wealth of information. In addition, it has been found that a number of three or four visual display units, for example screens and/or projection surfaces, represents an optimum, as far as the readability of the information on the screens is concerned, when a typical process image is shown distributed over the screens. The memory size of at least 32 MB is likewise a particularly suitable size for easily providing an “image split function” on the graphics card in the latter's internal memory, preferably a RAM store, and for achieving a sufficiently high processing speed and/or sufficiently fast image setup for the representation.

Hence, the invention also results in the use of an at least three-channel, preferably four-channel, graphics adapter having a graphics-adapter-internal memory, which is capable of ascertaining the split of a process image which is to be shown on a plurality of visual display units over the visual display units and of driving the visual display units for the purpose of showing the process image using the respective associated process image split data ascertained, in a process control system which comprises an image representation system having a plurality of visual display units.

An exemplary embodiment of the invention is illustrated below.

In the drawing:

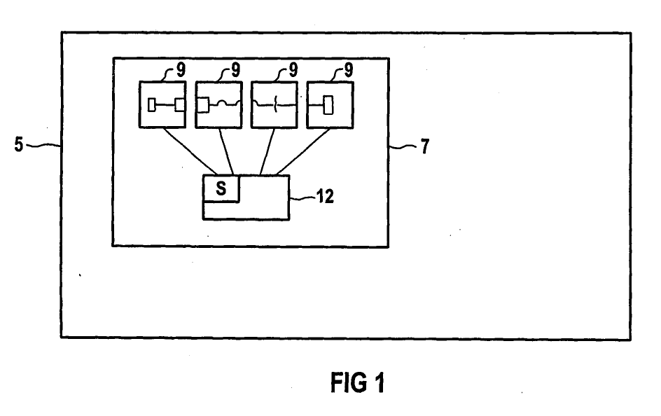

FIG. 1 shows a process control system in accordance with the invention, and

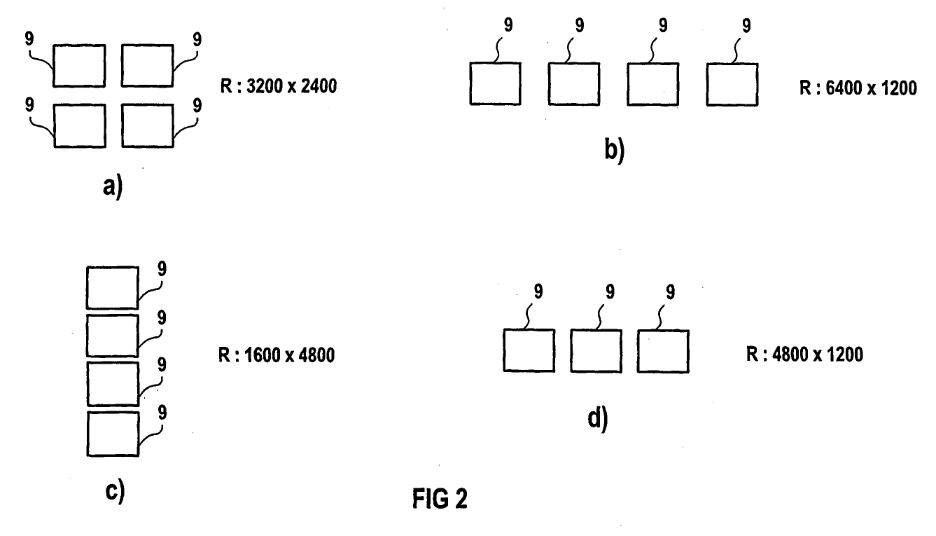

FIG. 2 shows an overview of particularly preferred arrangements of visual display units and image resolutions in a process control system in accordance with the invention.

FIG. 1 shows a process control system 5 in accordance with the invention which has an image representation system 7. The image representation system 7 comprises four visual display units 9, for example commercially available computer screens or else modules of a large-image projection system. The display units 9 can naturally be moved together as closely as their design allows, with the result that just the smallest possible bridge remains between the image areas of each of the visual display units 9.

A graphics adapter 9, for example a graphics card for a PC which is able to run under Microsoft Windows, contains a graphics-adapter-internal memory S in which the distribution of a process image's representation over the visual display units 9 is ascertained. The graphics adapter 12 drives the visual display units 9 using respective signals associated with the ascertained split, so that a process image can be shown distributed over the visual display units.

In this exemplary embodiment of the invention, a separate image split computer is not necessary for achieving a process image's representation distributed over the visual display units 9.

FIG. 2 shows particularly preferred arrangements of visual display units 9 in a process control system in accordance with the invention: in FIG. 2a, four visual display units 9 are arranged in a matrix comprising two rows and four columns; hence, a total image area with a resolution R of 3200×3400 pixels can be achieved, for example. In FIG. 2b, four visual display units 9 are arranged in a row; thus, a total image area with a resolution R of 6400×1200 pixels can be produced, for example. FIG. 2c shows the arrangement of four visual display units 9 in a column, which means that a total image area with a resolution R of 1600×4800 pixels can be achieved, for example. Finally, FIG. 2d shows the arrangement of three visual display units 9 in a row, which means that a total image area with a resolution R of 4800×1200 pixels can be achieved, for example.

The visual display units from FIG. 2 can naturally be moved together as tightly as possible, so that the respective bridges remaining between the individual image areas are as small as possible.

The total image areas which can be achieved which have been illustrated up to now in connection with FIG. 2 are based on a graphics adapter resolution of 1600×1200 pixels per channel. If another resolution per channel is available, for example 800×600 pixels or 1024×768 pixels, then the total area's resolution which can thus be achieved in each case is to be determined accordingly.

With particular preference, the image resolution of the channels of the graphics adapter can be adjusted and/or altered, so that a suitable total image resolution can be chosen, depending on the use of the process control system in accordance with the invention.

1. A process control system,
characterized in that
the process control system (5) comprises an image representation system (7) which can be used to split a process image over a plurality of visual display units (9), where the image representation system (7) comprises a graphics adapter (12) which is capable of ascertaining the split of the process image over the visual display units (9) in a graphics-adapter-internal memory (S) and of driving the visual display units (9) for the purpose of showing the process image using the respective associated process image split data ascertained.

2. The process control system as claimed in claim 1, where the graphics adapter (12) is a PC-compatible graphics card having at least three, preferably four, video channels, and the graphics-adapter-internal memory (S) has a minimum size of 32 MB per video channel.

3. The use of an at least three-channel, preferably four-channel, graphics adapter (12) having a graphics-adapter-internal memory (S), which is capable of ascertaining the split of a process image which is to be shown on a plurality of visual display units over the visual display units and of driving the visual display units for the purpose of showing the process image using the respective associated process image split data ascertained, in a process control system (5) which comprises an image representation system (7) having a plurality of visual display units (9).
